(19) United States
(12) Patent Application Publication
(10) Pub. No.: US 2015/0109937 A1
(43) Pub. Date: Apr. 23, 2015

(54) METHOD OF IMPLEMENTING PACKET SEARCH BY DOUBLE SLIDING WINDOWS

(71) Applicant: Inspur Electronic Information Industry Co., Ltd, Jinan City (CN)

(72) Inventors: Endong WANG, Jinan City (CN); Leijun HU, Jinan City (CN); Rengang LI, Jinan City (CN)

(21) Appl. No.: 14/534,379

(22) Filed: Nov. 6, 2014

Related U.S. Application Data
(63) Continuation of application No. PCT/CN2014/071221, filed on Jan. 23, 2014.

(30) Foreign Application Priority Data
Oct. 20, 2013 (CN) 201310053862.6

(51) Int. Cl. H04L 12/26

(52) U.S. Cl. CPC H04L 43/50
USPC 370/241

(57) ABSTRACT

A method of implementing packet search by double sliding windows is provided. The method adopts a three-level barrel shift register to store input packet data, and a position of a sliding window 1 is determined at 32 positions by primary testing of a link, so as to ensure that the packet data is located at the center of the sliding window 1, thereby ensuring that the position of the sliding window 1 meets a transmission characteristic of a specific link to the maximum extent. After the position of the sliding window 1 is determined, 32-bit packet data can be effectively searched in the sliding window 1 by dynamically adjusting a sliding window 2, and 32-bit transmission offset is allowed for the packet data. The method of implementing packet search by double sliding windows meets a transmission characteristic of a specific link to the maximum extent.

### TECHNICAL FIELD OF THE INVENTION

The disclosure herein relates to the field of high-end server design and the field of large-scale integrated circuit design, and in particular, to a method of implementing packet search by double sliding windows.

### BACKGROUND

Along with rapid development of computer technologies and integrated circuit technologies, in order to meet requirements of economic and social development, high-end server systems become one of bottlenecks in key fields restraining social development. Information fields such as enormous data calculation and data analysis, complicated graphical analysis, and scientific computation have extremely high requirements on performance of a computer system. Therefore, it is required to construct a huge high-end server system to better adapt to application requirements of various current fields. However, on the other hand, a technical problem of high-speed interconnection packet transmission is also encountered, and in a high-speed interconnection interface, transmission differences caused by trace delay and transmission consistency difference of multi-channel transmission all influence stability and execution efficiency of the system. Therefore, adopting a reasonable implementation manner and controlling a transmission characteristic of a link so as to enable a packet transmission method to meet a transmission characteristic of a specific link is one of effective methods for implementing stable transmission of a high-speed interconnection interface in a high-end server system.

### SUMMARY

Embodiments of method of implementing packet search by double sliding windows are provided.

Some embodiments are implemented in the following manner, a three-level barrel shift register is used to store input packet data, a position of a sliding window 1 is determined at 32 positions by primary testing of a link, so as to ensure that the packet data is located at the center of the sliding window 1, thereby ensuring that the position of the sliding window 1 meets a transmission characteristic of a specific link to the maximum extent. After the position of the sliding window 1 is determined, 32-bit packet data can be effectively searched in the sliding window 1 by a dynamical adjustment manner of a sliding window 2, and 32-bit transmission offset is allowed for the packet data. A system structure used for the method of implementing packet search by double sliding windows includes: (1) a first-level sliding window, and (2) a second-level sliding window, wherein:
the first-level sliding window refers to that: according to a design specification and a transmission characteristic requirement of a physical link, transmission performance thereof is analyzed, and a specific position of the first-level sliding window is determined by primary testing, so that the packet data is located at the center of the sliding window 1, thereby ensuring that the first-level sliding window meets the transmission characteristic of the specific link to the maximum extent, and different first-level sliding windows are allowed for different transmission links because of their different trace delays;
the second-level sliding window refers to that: on the basis of the determined first-level sliding window, a specific position of the packet data is searched for by dynamically adjusting in the range of the first-level sliding window through the second-level sliding window, wherein the allowed maximum offset of the packet data is 32 bits; packet search is performed by using double sliding windows, thereby implementing reliable and stable high-speed link packet transmission; transmission characteristic management on every transmission link can be performed by the first-level sliding window, enabling the position of the first-level sliding window to meet every transmission link, enabling a transmission characteristic of every link to be matched with a different sliding window, thereby ensuring the efficiency and stability of the link transmission to the maximum extent; because the position of the first-level sliding window is set to enable the packet data to be located at the center thereof, the dynamic adjustment of the second-level sliding window is ensured more reliably, thereby improving consistency of multi-channel packet transmission.

Because of structure features of high-speed transmission link interfaces and design features of high-speed interconnection protocols, as well as transmission influence brought about by high-speed link transmission trace delay and inconsistency of multi-channel packet transmission, the position of the first-level sliding window is determined by using evaluation and prediction, so as to faintly ensure that the packet data is located at the center of the first-level sliding window; moreover, positions of first-level sliding windows in different channels of the multi-channel system may be different, thereby implementing a close match between the sliding window structure and the transmission link characteristic.

The embodiment of the disclosure herein has the following beneficial effects: the method of implementing packet search by double sliding windows improves stability of high-speed link packet transmission and consistency of multi-channel packet transmission, thereby having a high technical value and application value in the fields of high-speed interconnection interface logic or protocol implementation.

### BRIEF DESCRIPTION OF THE DRAWINGS

FIG. 1 is a schematic diagram of a two-level sliding window structure;

FIG. 2 is a schematic diagram of a first-level sliding window structure;

FIG. 3 is a schematic diagram of a second-level sliding window structure.

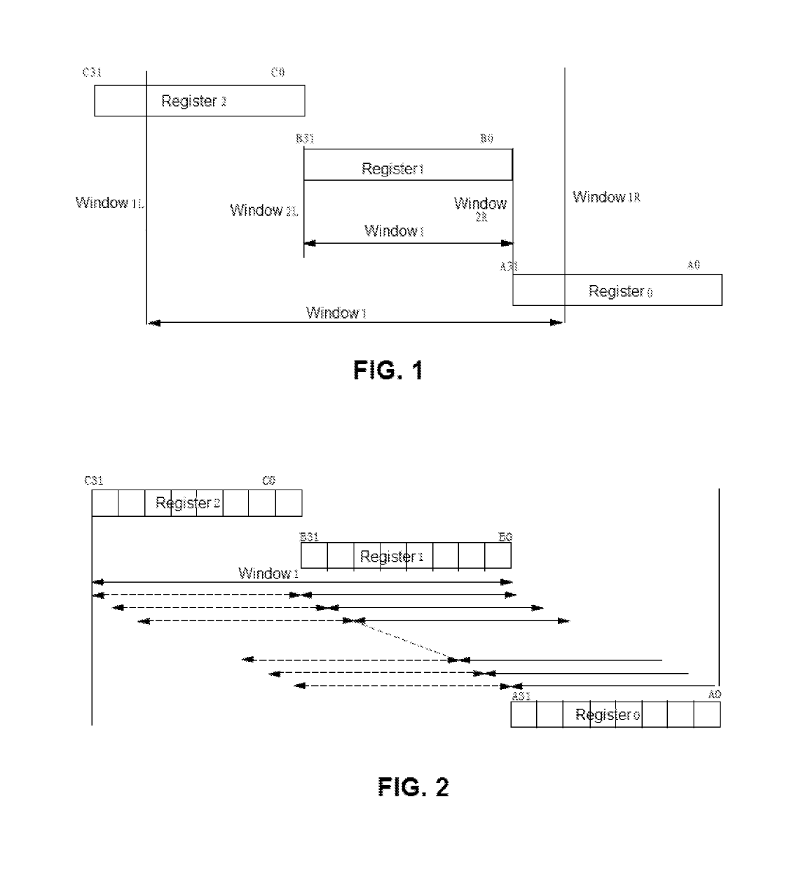

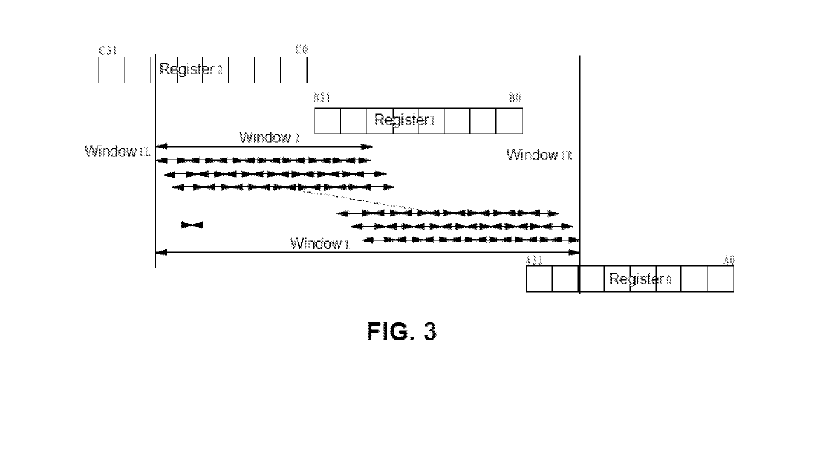

### DETAILED DESCRIPTION

The method of the disclosure herein is described in detail in the following with reference to the accompanying drawings.

Characteristics of a first-level sliding window implementation structure mainly refers to that: according to a design specification and a transmission characteristic requirement of a physical link, transmission performance thereof is analyzed, and a specific position of the first-level sliding window is determined by primary testing, so that packet data is located at the center of the sliding window 1, thereby ensuring that the first-level sliding window meets the transmission characteristic of a specific link to the maximum extent, and first-level sliding windows may be different for different transmission links because of their different trace delays. Characteristics of a second-level sliding window implementation structure mainly refers to that: on the basis of the determined first-level sliding window, a specific position of the packet data may be searched for by dynamically adjusting in the range of the first-level sliding window through the second-level sliding window, where the allowed maximum offset of the packet data is 32 bits. The method of implementing packet search by double sliding windows implements reliable and stable high-speed link packet transmission. Transmission characteristic management on every transmission link can be performed by the first-level sliding window, enabling the position of the first-level sliding window to meet every transmission link, enabling a transmission characteristic of every link to be matched with a different sliding window, thereby ensuring the efficiency and stability of the link transmission to the maximum extent. The position for packet search may be dynamically adjusted by using the second-level sliding window, where the allowed transmission offset of the packet does not exceed 32 bits, and because the position of the first-level sliding window is set to enable the packet data to be located at the center thereof, the dynamic adjustment of the second-level sliding window is ensured more reliably.

As described in the summary of the disclosure, an implementation structure for the method of implementing packet search by double sliding windows in the disclosure herein mainly includes: a first-level sliding window implementation structure (1), and a second-level sliding window implementation structure (2).

After external 32-bit packet data is input to the double sliding window module, the packet data passes through three barrel shift registers reg0, reg1 and reg2, where the barrel shift registers each have a bit width of 32 bits and a depth of 32. A sliding window 1 may slide from B0-C31 to A0-B31, totally 32 bits. According to rules and characteristics of hardware physical design, or according to a result analysis of hardware test, a characteristic of each transmission channel is determined, so as to determine a specific position of the sliding window 1. For example, when the 32-bit packet data falls in reg1[18]-reg2[17] due to trace delay, the sliding window 1 may be placed at the position B0-C31, so that the packet data is located at the center of the sliding window; when the 32-bit packet data falls in reg0[30]-reg2[29], the sliding window 1 may be placed at the position A14-C13, so that the packet data is located at the center of the sliding window; and when the 32-bit packet data falls in reg1[8]-reg2[7], the sliding window 1 may be placed at the position A24-C23, so that the packet data is located at the center of the sliding window.

After the position of the sliding window 1 is determined, for example, the sliding window 1 is located at the position A24-C23, a sliding window 2 may slide from B28-C27 to A28-B27, totally 32 bits, and a packet may be searched for effectively in this interval according to the specific position of packet search during transmission.

Except the technical features described in the specification, others are all well-known technologies for persons skilled in the art.

1. A method of implementing packet search by double sliding windows, comprising:
a three-level barrel shift register is used to store input packet data, a position of a sliding window 1 is determined at 32 positions by primary testing of a link, so as to ensure that the packet data is located at the center of the sliding window 1, thereby ensuring that the position of the sliding window 1 meets a transmission characteristic of a specific link to the maximum extent; after the position of the sliding window 1 is determined, 32-bit packet data can be effectively searched in the sliding window 1 by a dynamical adjustment manner of a sliding window 2, 32-bit transmission offset is allowed for the packet data, and a system structure used for the method of implementing packet search by double sliding windows comprises: (1) a first-level sliding window, and (2) a second-level sliding window, wherein:
the first-level sliding window refers to that: according to a design specification and a transmission characteristic requirement of a physical link, transmission performance thereof is analyzed, and a specific position of the first-level sliding window is determined by primary testing, so that the packet data is located at the center of the sliding window 1, thereby ensuring that the first-level sliding window meets the transmission characteristic of the specific link to the maximum extent, and different first-level sliding windows are allowed for different transmission links because of their different trace delays;
the second-level sliding window refers to that: on the basis of the determined first-level sliding window, a specific position of the packet data is searched for by dynamically adjusting in the range of the first-level sliding window through the second-level sliding window, wherein the allowed maximum offset of the packet data is 32 bits; packet search is performed by using double sliding windows, thereby implementing reliable and stable high-speed link packet transmission; transmission characteristic management on every transmission link can be performed by the first-level sliding window, enabling the position of the first-level sliding window to meet every transmission link, enabling a transmission characteristic of every link to be matched with a different sliding window, thereby ensuring the efficiency and stability of the link transmission to the maximum extent; because the position of the first-level sliding window is set to enable the packet data to be located at the center thereof, the dynamic adjustment of the second-level sliding window is ensured more reliably, thereby improving consistency of multi-channel packet transmission.

2. The packet search method according to claim 1, wherein:
because of structure features of high-speed transmission link interfaces and design features of high-speed interconnection protocols, as well as transmission influence brought about by high-speed link transmission trace delay and inconsistency of multi-channel packet transmission, the position of the first-level sliding window is determined by using evaluation and prediction, so as to faintly ensure that the packet data is located at the center of the first-level sliding window; moreover positions of first-level sliding windows in different channels of the multi-channel system may be different, thereby implementing a close match between the sliding window structure and the transmission link characteristic.
